(19) United States
(12) Patent Application Publication
(10) Pub. No.: US 2014/0253281 A1
(43) Pub. Date: Sep. 11, 2014

(54) Electrode Material for Thermal Fuses, Manufacturing Method Therefor and Thermal Fuse Comprising the Same

(71) Applicants: Naoshi Suzaki, Tokyo (JP); Hideo Kumita, Tokyo (JP)

(72) Inventors: Naoshi Suzaki, Tokyo (JP); Hideo Kumita, Tokyo (JP)

(73) Assignee: Tokuriki Honten Co., Ltd., Tokyo (JP)

(21) Appl. No.: 14/131,146

(22) PCT Filed: Jul. 5, 2012
(86) PCT No.: PCT/JP2012/067211

§ 371 Date: May 28, 2014

(30) Foreign Application Priority Data
Jul. 6, 2011 (JP) 2011-150483 2011

(51) Int. Cl. H01H 37/32; C22F 1/14; C22F 1/08

(52) U.S. Cl. CPC H01H 37/32; C22F 1/08; C22F 1/14
USPC 337/416; 428/469; 148/684; 148/678

(57) ABSTRACT

[Problem to be solved]

For an Ag—CuO alloy based electrode material for thermal fuses, rolling workability is significantly decreased as the content of CuO is increasing, and the reduction of a plate thickness is difficult in the rolling process after internal oxidation.

[Solution]

An electrode material for thermal fuses comprising 50 to 99 mass % of Ag and 1 to 50 mass % of Cu is provided, the material having a structure in which an internal oxidation layer is formed at each of the front and back surfaces, and having a non-oxidized layer in the central portion.

### TECHNICAL FIELD

The present invention relates to an electrode material for thermal fuses used in electronic equipment and home appliances to prevent abnormal increase in temperature for these devices, a manufacturing method thereof and a thermal fuse comprising the electrode material.

### BACKGROUND ART

Thermal fuses used to prevent devices from developing abnormally high temperature, will shut off electrical current by the following mechanism: a temperature sensitive pellet is melted at an operating temperature to release a strong compressed spring, and then the extension of the strong compressed spring will separate an electrode material and a lead wire which are press-contacted by the strong compressed spring. An Ag—CdO alloy is commonly used as the electrode material. However, use of an Ag—CdO alloy is limited in view of environmental problems because Cd is a toxic substance.

Further, in the case of an Ag—CdO alloy, a melt adhesion phenomenon with a metal housing may occur because an electrode material is used as a thin plate, and the passage of electrical current through the contacting surface with a lead wire is maintained for a long time. In that case, a problem is that the Ag—CdO alloy cannot function as a thermal fuse. To address the above problem, melt adhesion resistance can be improved by increasing the content of CdO in the Ag—CdO alloy. However, the function of a thermal fuse will be adversely affected because contact resistance increases as the content of CdO increases, which causes increase in temperature at the contact portion.

Accordingly, in recent years, an Ag—CuO alloy has been used for an electrode material for thermal fuses (for example, see Patent Literature 1, Patent Literature 2).

### CITATION LIST

### Patent Literatures

Patent Literature 1: Japanese Unexamined Patent Application Publication No. H10-162704
Patent Literature 2: Japanese Patent No. 4383859

### SUMMARY OF INVENTION

### Technical Problem

Such an Ag—CuO alloy is becoming the mainstream for electrode materials for thermal fuses, but there are demands for increasing the content of CuO in order to lower the price and also for reducing a plate thickness.

However, in the Ag—CuO alloy, rolling workability is significantly reduced as the content of CuO is increasing, and processing into a thin plate may be difficult at the rolling process after internal oxidation. In particular, conventionally, a material having a Cu content of more than 20 mass % can not be processed by 50% or more in terms of the cross-sectional reduction rate.

An object of the present invention is to solve the above problem.

### Solution to Problem

According to the present invention, an electrode material is provided having a structure in which an internally oxidized layer 3 is formed at each of the front and back surfaces of an internally oxidizable alloy comprising 50 to 99 mass % of Ag and 1 to 50 mass % of Cu, and having a non-oxidized layer in the central portion.

Internal oxidation treatment involves a process in which Cu contained in Ag by pre-dissolution precipitates as oxides in the Ag matrix by binding to oxygen which is occluded into Ag through a surface layer of the material. At this time, a phenomenon occurs in which Cu, a solute element, diffuses toward the surface layer from the central portion of the material.

This diffusion phenomenon refers to a phenomenon in which Cu diffuses toward a surface layer from a non-oxidized layer to counteract a concentration gradient created by difference in the concentrations between an internally oxidized layer comprising oxides precipitated from the surface of the material toward the interior portion, and the non-oxidized layer, not showing precipitation over time.

The present invention is characterized in that only a surface layer of a material forms an internally oxidized structure in the internal oxidation treatment, and conditions for achieving this are adjusted so that they fall in 600° C. to 750° C., 1 to 5 hours and 1 to 5 atm of oxygen pressure in an internal oxidation furnace. By this, a layer which is not oxidized, i.e., a non-oxidized layer can be formed in the central portion of the material (FIGS. 1 to 3).

A thin plate material of 0.1 mm or less is used for an electrode material for thermal fuses based on the structure of thermal fuses, and therefore, a material after internal oxidation needs to be rolled into 0.1 mm or less.

Further, increased oxide content and a reduced plate thickness are demanded for the purpose of cost reduction. However, according to the conventionl manufacturing methods, a material having a Cu content of mroe than 20 mass % can not be rolled by 50% or more in terms of the corss-sectional reduction rate as described above. This is because rolling workability is significantly reduced as oxides are increasing.

According to the present invention, by forming a non-oxidized layer between internally oxidized layers, increase in contact resistance can be controlled, and rolling process can be successfully performed by 70% or more in terms of the cross-sectional reduction rate even if 50 mass % of Cu is contained.

The reasons for adding 1 to 50 mass % of Cu herein are as follows: an internally oxidized alloy good enough for use as an electrode material for thermal fuses can not be obtained in a case where the content of Cu is less than 1 mass %; and in the case of more than 50 mass %, temperature will increase due to increased contact resistance, which is not suitable for an electrode material for thermal fuses and a thermal fuse comprising the electrode material.

Further, provided is a structure in w3hich an internally oxidized layer is formed at each of the front and back surfaces of an internally oxidizable alloy comprising 50 to 99 mass % of Ag, 1 to 50 mass % of Cu and 0.1 to 5 mass % of at least one of Sn and In, and having a non-oxidized layer in the central portion.

By adding Sn and/or In, a composite oxide with Cu, for exampie (Cu—Sn)Ox can be obtained, showing an effect of improving melt adhesion resistance.

The reasons for having 0.1 to 5 mass % of at least one of Sn and In herein are as follows: in the case of less than 0.1 mass %, and effect of improving melt adhesion resistance can not be shown; and in the case of more than 5%, contact resistance is increased.

Further, provided is a structure in which an internally oxidized layer is formed at each of the front and back surfaces of an internally oxidizable alloy comprising 50 to 99 mass % of Ag, 1 to 50 mass % of Cu and 0.01 to 1 mass % of at least one of Fe, Ni and Co, and having a non-oxidized layer in the central portion.

In the process of the aforementioned diffusion, the diffusion phenomenon due to the concentration gradient can be controlled by adding at least one of Fe, Ni and Co. As a result of this, an oxidized structure can be micronized by controlling aggregation due to the movement of precipitated oxides to obtain homogeneous dispersion.

The reasons for having 0.01 to 1 mass % of at least one of Fe, Ni and Co herein are as follows: in the case of less thatn 0.01 mass %, the movement of dissolved elements upon internally oxidation treatment can not be sufficiently controlled, and the homogeneous dispersion of oxides can not be obtained; and in the case of more than 1 mass %, coarse oxides may be formed at a crystal grain boundary and the like, causing increased contact resistance.

Further, provided is a structure in which an internally oxidized layer is formed at each of the front and back surfaces of an internally oxidizable alloy comprising 50 to 99 mass % of Ag, 1 to 50 mass % of Cu, 0.1 to 5 mass % of at least one of Sn and In and further 0.01 to 1 mass % of at least one of Fe, Ni and Co, and having a non-oxidized layer in the central portion.

Moreover, provided is a thermal fuse having a temperature sensitive pellet wherein the above electrode material is used therein.

### Advantageous Effects of Invention

According to the electrode material of the present invention, an inexpensive electrode material for thermal fuses and a thermal fuse comprising the electrode material can be obtained having the following advantages: the content of Cu is allowed up to 50 mass %; in the process after internal oxidation, rolling process can be performed by 70% or more in terms of the cross-sectional rejection rate; even in a case where the plate thickness is reduced by rolling process, internally oxidized layers and a non-oxidised layer are present; and there are no risks such as abnormal abrasion and melt adhesion when used as an electrode material for thermal fuses.

### BRIEF DESCRIPTION OF DRAWINGS

FIG. 1 shows a schematic drawing illustrating a material before the internal oxidation step.

FIG. 2 shows a schematic drawing illustrating a material after the internal oxidation step.

FIG. 3 shows a schematic drawing illustrating an internally oxidized contact after rolling.

FIG. 4 shows a cross-sectional view of a thermal fuse having a temperature-sensitive pellet.

### DESCRIPTION OF EMBODIMENTS

Examples of the present invention are showa in Tables 1 and 2, and the processing steps of these electrode materials for thermal fuses will be described below.

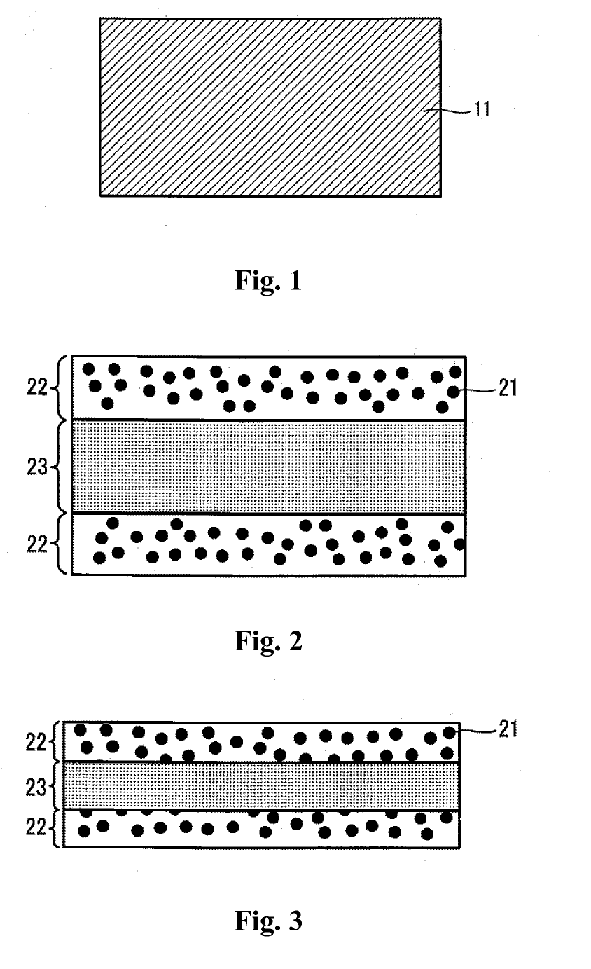

First, a predetermined material was dissolved, and an internally oxidizable alloy 11 having a plate thickness of 0.5 mm was obtained by rolling process (FIG. 1).

The internally oxidizable alloy 11 is subjected to internal oxidation in an internal oxidation furnace under the following conditions of 600° C. to 750° C. 1 to 5 hours and 1 to 5 atm of oxygen pressure (FIG. 2). At this time, conditions are selected within the each range described above depending on the composition of an internally oxdidizable alloy so that an internally oxidized layer 22 having an oxide 21 only at the front and back surfaces can be obtained, and a non-oxidized layer 23 is present in the middle. Further, depending on the composition of the above material, rolling process and full annealing are repeated if needed to obtain an alloy before the final processing. The thickness of the alloy before the final processing is shown in Table 2 as an intermediate plate thickness. Then, processing is performed until the final processing rate when rolled from the intermediate plate thickness to the final plate thickness reaches 70% or more in terms of the cross-sectional reduction rate from the intermediate plate thickness (FIG. 3).

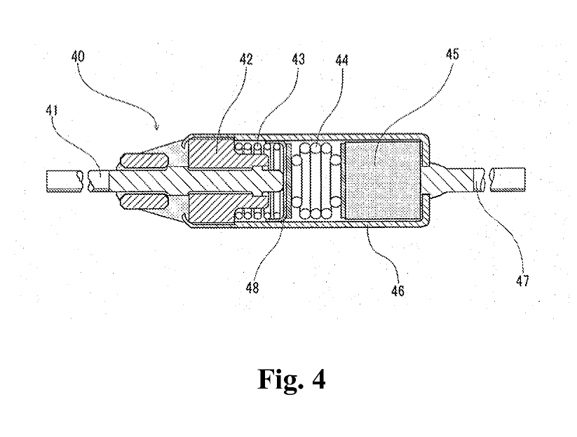

The electrode materials described above can be suitably used for a commercially available typical thermal fuse having a temperature-sensitive pellet. For example, as shown in FIG. 4, they can be applied to a thermal fuse having a temperature-sensitive pellet 40, comprising a leads 41 and 47, an insulating material 42, two compressed springs 43 and 44 having different strengths, an electrode for thermal fuses 48, a temperature-sensitive material 45, a metal housing 46 and the like as major components. When an electronic device connected to the above thermal fuse is overheated, and a predetermined operating temperature is reached, the temperature-sensitive material 45 deforms to unload the compressed springs 43 and 44. Then the compressed state of the weak compressed spring 43 is released following the extension of the strong compressed spring 44, resulting in the extension of the weak compressed spring 43. This causes the electrode for thermal fuses 48 to move with keeping contact with the inside of the metal housing 46. Then electrical current is shut-off without melt adhesion of the contact.

The electrode materials described above are incorporated into thermal fuses (FIG. 4) as an electrode material for thermal fuses, and energization tests and electric current shut-off tests weere performed. The results are shown in Table 1.

### Table 1

Examples 1 to 15 each show Example of the present invention. Used are the electrode materials having a structure in which an internally oxidized layer is formed at each of the front and back surfaces of an internally oxidized alloy, and having a non-oxidized layer in the central portion of the alloy.

Cxomparative Examples 1 to 8 each show Comparative Example according to the conventional manufacturing method. Used are the electrode materials in which internal oxidation treatment was performed without leaving a non-oxidized layer in the central portion of an internally oxidized alloy.

In Table 1, with regard to workability, “Good” was assigned to those which was able be rolled to a final processing rate of 70% or more in terms of the cross-sectional reduction rate, and “poor” was assigned to those which was not. Workability “poor” indicates that a crack and fracture in the electrode materials, a crack in the internally oxidized layers or the like occurred during rolling process.

Energization tests: “Good” was assigned to those which did not show more than 10° C. increase in temperature when energized for 10 minutes under the conditions of DC 30 V and 10 A, and “poor” was assigned to those which showed.

Shut-off tests: the shut-off tests were performed as follows: energization was performed for 10 minutes under the conditions of DC 30 V and 10 A, and then the temperature of the measurement environment was raised to a temperature higher than the operating temperature by 10° C. while continuing energization. “Good” was assigned to those which did not show melt adhesion, and “poor” was assigned to those which showed.

### Table 2

Table 2 corresponds to Table 1, and each shows the conditions of the internal oxidation treatment, the final processing rate from the intermediate plate thickness to the final plate thickness in Examples 1 to 15 and Comparative Examples 1 to 8 of the present invention.

### DESCRIPTION OF REFERENCE NUMERALS

11: Internally oxidizable alloy
21: Oxide
22: Internally oxidized layer
23: Non-oxidized layer
40: Thermal fuse
41, 47: Lead wire
42: Insulating material
43: Weak compressed spring
44: Strong compressed spring
45: Temperature-sensitive material
46: Metal housing
48: Electrode for thermal fuses

TABLE 1

| | | Component Composition (mass %) | | | | | | | | Final | | |
|---|---|---|---|---|---|---|---|---|---|---|---|---|
| | | Component Composition | | | | | | | | Plate | | |
| Type of | | of Raw Material | | | | | | Ag and | | Thickness | Energization | Shut-off |
| Contact | | Cu | Sn | In | Fe | Co | Ni | Impurities | Workability | (mm) | Test | Test |
| Example | 1 | 1.0 | | | | | | Remainder | good | 0.1 | good | good |
| | 2 | 10.0 | | | | | | Remainder | good | 0.05 | good | good |
| | 3 | 13.0 | | | | | | Remainder | good | 0.05 | good | good |
| | 4 | 20.0 | | | | | | Remainder | good | 0.06 | good | good |
| | 5 | 35.0 | | | | | | Remainder | good | 0.06 | good | good |
| | 6 | 50.0 | | | | | | Remainder | good | 0.09 | good | good |
| | 7 | 9.0 | 0.1 | 5.0 | | | | Remainder | good | 0.06 | good | good |
| | 8 | 20.0 | | | | | 1.0 | Remainder | good | 0.07 | good | good |
| | 9 | 10.0 | | 0.1 | | | | Remainder | good | 0.08 | good | good |
| | 10 | 15.0 | 5.0 | | | | | Remainder | good | 0.05 | good | good |
| | 11 | 8.0 | 3.0 | | 0.1 | | | Remainder | good | 0.05 | good | good |
| | 12 | 30.0 | 2.0 | 2.0 | | 0.01 | 0.5 | Remainder | good | 0.06 | good | good |
| | 13 | 12.0 | | | | 0.1 | | Remainder | good | 0.06 | good | good |
| | 14 | 5.0 | 3.0 | 0.5 | 0.5 | | 0.01 | Remainder | good | 0.08 | good | good |
| | 15 | 1.0 | | 4.5 | 1.0 | | 0.2 | Remainder | good | 0.1 | good | good |
| Comparative | 1 | 20.0 | | 1.5 | | | | Remainder | poor | | | |
| Example | 2 | 30.0 | 0.1 | | | | | Remainder | poor | | | |
| | 3 | 22.0 | | | | 0.1 | | Remainder | poor | | | |
| | 4 | 30.0 | 2.0 | 2.0 | | 0.01 | 0.5 | Remainder | poor | | | |
| | 5 | 35.0 | | | | | | Remainder | poor | | | |
| | 6 | 50.0 | | | | | | Remainder | poor | | | |
| | 7 | 20.0 | | | | | 1.0 | Remainder | poor | | | |
| | 8 | 1.0 | | | | | | Remainder | poor | | | |

TABLE 2

| | | Final | Intermediate | Internal | Internal | Oxygen |
|---|---|---|---|---|---|---|
| Type of | | Processing | Plate Thickness | Oxidation | Oxidation | Pressure |
| Contact | | Rate (%) | (mm) | Temperature (° C.) | Time (h) | (atm) |
| Example | 1 | 80 | 0.50 | 600 | 1 | 1 |
| | 2 | 90 | 0.50 | 620 | 2 | 1 |
| | 3 | 85 | 0.33 | 630 | 2 | 2 |
| | 4 | 82 | 0.33 | 650 | 3 | 3 |
| | 5 | 80 | 0.30 | 700 | 4 | 5 |
| | 6 | 70 | 0.30 | 750 | 5 | 5 |
| | 7 | 83 | 0.31 | 630 | 3 | 2 |
| | 8 | 77 | 0.30 | 660 | 2 | 3 |
| | 9 | 83 | 0.47 | 640 | 2 | 2 |
| | 10 | 80 | 0.25 | 670 | 3 | 3 |
| | 11 | 83 | 0.31 | 630 | 3 | 3 |
| | 12 | 72 | 0.21 | 700 | 5 | 5 |
| | 13 | 70 | 0.20 | 630 | 2 | 2 |
| | 14 | 76 | 0.33 | 650 | 3 | 3 |
| | 15 | 75 | 0.40 | 640 | 3 | 3 |
| Comparative | 1 | 45 | 0.30 | 680 | 24 | 5 |
| Example | 2 | 25 | 0.30 | 700 | 28 | 5 |
| | 3 | 47 | 0.33 | 680 | 30 | 3 |
| | 4 | 15 | 0.21 | 700 | 40 | 5 |
| | 5 | 17 | 0.30 | 720 | 35 | 3 |
| | 6 | 10 | 0.30 | 750 | 40 | 5 |
| | 7 | 46 | 0.30 | 680 | 24 | 3 |
| | 8 | 69 | 0.50 | 620 | 30 | 2 |

1. An electrode material for thermal fuses comprsing 50 to 99 mass % of Ag and 1 to 50 mass % of Cu, the electrode material having a structure in which an internally oxidized layer is formed at each of front and back surfaces, and having a non-oxidized layer in a central portion.

2. The electrode material for thermal fuses according to claim 1, further comprising 0.1 to 5 mass % of at least one of Sn and In.

3. The electrode material for thermal fuses according to claim 1, further comprising 0.01 to 1 mass % of at least one of Fe, Ni and Co.

4. The electrode material for thermal fuses according to claim 1, further comprising 0.1 to 5 mass % of at least one of Sn and In, and comprising 0.01 to 1 mass % of at least one of Fe, Ni and Co.

5. A method of manufacturing an electrode material for thermal fuses having 50 to 99 mass % of Ag and 1 to 50 mass % of Cu, the electrode material having a structure in which an internally oxidized layer is formed at each of front and back surfaces, and having a non-oxidized layer in a central portion, the method comprising: dissolving a predetermined material; performing rolling process to give a material having a predetermined thickness; placing the material in an internal oxidation furnace; forming an internally oxidized layer only at the front and back surface layers of the electrode material while leaving a non-oxidized layer in the middle of the material under the conditions of 600° C. to 750° C., 1 to 5 hours and 1 to 5 atm of oxygen pressure; then repeating rolling process and annealing to the material; and performing rolling process so that a final processing rate is 70% more in terms of a cross-sectional reduction rate such that the internally oxidized layers and the non-oxidized layer remain after reducing a plate thickness.

6. A thermal furse comprising an electrode material comprising 50 to 99 mass % of Ag and 1 to 50 mass % of Cu, the electrode material having a structure in which an internally oxidized layer is formed at each of the front and back surfaces, and having a non-oxidized layer in the central portion.

7. The thermal fuse according to claim 6, wherein the electrode material further comprises 0.1 to 5 mass % of at least one of Sn and In.

8. The termal fuse according to claim 6, wherein the electrode material further comprises 0.01 to 1 mass % of at least one of Fe, Ni and Co.

9. The thermal fuse according to claim 6, wherein the electrode material further comprises 0.1 to 5 mass % of at least one of Sn and In, and comprising 0.01 to 1 mass % of at least one of Fe, Ni and Co.

10. The method according to claim 5, the electrode material further comprising 0.1 to 5 mass % of at least one of Sn and In.

11. The method according to claim 5, the electrode material further comprising 0.01 to 1 mass % of at least one of Fe, Ni and Co.

12. The method according to claim 5, the electrode material further comprising 0.1 to 5 mass % of at least one of Sn and In, and comprising 0.01 to 1 mass % of at least one of Fe, Ni and Co.
